(19) United States
(12) Patent Application Publication
(10) Pub. No.: US 2026/0022886 A1
(43) Pub. Date: Jan. 22, 2026

(54) DEVICE FOR DRYING ELECTRODES

(71) Applicant: SK ON CO., LTD., Seoul (KR)

(72) Inventors: Na Eun GIL, Daejeon (KR); Min Cheol KIM, Daejeon (KR); Hyun Ji KIM, Daejeon (KR); Jong Hyeok LEE, Daejeon (KR); Yoon Ji JO, Daejeon (KR); Chang Mook HWANG, Daejeon (KR)

(21) Appl. No.: 19/267,672

(22) Filed: Jul. 14, 2025

(30) Foreign Application Priority Data
Jul. 16, 2024 (KR) 10-2024-0093585

(51) Int. Cl. F26B 13/14; F26B 25/14

(52) U.S. Cl. CPC F26B 13/14; F26B 25/14

(57) ABSTRACT

A device for drying electrodes include: a drying chamber having a drying space formed therein and comprising a drying chamber inlet wall and a drying chamber outlet wall that face each other, an inlet chamber located outside the drying chamber and in contact with the drying chamber inlet wall; an outlet chamber located outside the drying chamber and in contact with the drying chamber outlet wall; a roll assembly including a plurality of transport rolls located in the drying space; and a heater assembly configured to provide heat to the drying space, wherein the drying chamber further include a partition located in the drying space to divide the drying space into a first drying space and a second drying space, and the heater assembly include a first heater configured to provide heat to the first drying space and a second heater configured to provide heat to the second drying space.

### CROSS-REFERENCE TO RELATED APPLICATION

This patent application claims the priority and benefits of Korean patent application No. 10-2024-0093585, filed on Jul. 16, 2024 the disclosure of which is incorporated herein by reference in its entirety.

### BACKGROUND

### 1. Field of the Invention

The present disclosure relates to a device for drying electrodes.

### 2. Description of the Related Art

In order to dry electrodes used in a secondary battery, heat may be applied to the electrodes. In addition, the pressure of the environment in which the electrode is dried may be lower than 1 atm. Research is ongoing to effectively dry the electrodes.

### SUMMARY

An embodiment of the present disclosure is to provide a device for drying electrodes that is configured to dry an electrode sheet at different temperatures in separate spaces with a time difference.

A device for drying electrodes may include: a drying chamber having a drying space formed therein and comprising a drying chamber inlet wall and a drying chamber outlet wall that face each other; an inlet chamber located outside the drying chamber and in contact with the drying chamber inlet wall; an outlet chamber located outside the drying chamber and in contact with the drying chamber outlet wall; a roll assembly including a plurality of transport rolls located in the drying space; and a heater assembly configured to provide heat to the drying space, wherein the drying chamber may further include a partition located in the drying space to divide the drying space into a first drying space and a second drying space, and the heater assembly may include a first heater configured to provide heat to the first drying space and a second heater configured to provide heat to the second drying space.

According to an embodiment of the present disclosure, there may be provided a device for drying electrodes that is configured to dry an electrode sheet at different temperatures in separate spaces with a time difference.

The device for drying electrodes of the present disclosure may be widely applied in green technology fields, such as electric vehicles, battery charging stations, as well as solar power generation, wind power generation, and the like, which use the batteries.

The device for drying electrodes of the present disclosure may be used in eco-friendly electric vehicles, hybrid vehicles, and the like, which are aimed at mitigating climate change by reducing air pollution and greenhouse gas emission.

### BRIEF DESCRIPTION OF THE DRAWINGS

The above and other embodiments, features and other advantages of the present disclosure will be more clearly understood from the following detailed description taken in conjunction with the accompanying drawings, in which:

FIG. 1 is a view illustrating a device for drying electrodes according to an embodiment of the present disclosure;

FIG. 2 is a view illustrating a drying chamber shown in FIG. 1;

FIG. 3 is a cross-sectional view of the drying chamber shown in FIG. 2, taken along line B1-B2;

FIG. 4 is a view illustrating a transit chamber shown in FIG. 1;

FIG. 5 is a cross-sectional view of the transit chamber shown in FIG. 4, taken along line C1-C2;

FIG. 6 is a view illustrating a suction unit according to an embodiment of the present disclosure;

FIG. 7 is a view illustrating the suction unit shown in FIG. 6 as viewed from a different angle;

FIG. 8 is a partial cross-sectional view of the suction unit shown in FIG. 7, taken along line D1-D2;

FIG. 9 is a view illustrating a state where transit rolls are arranged in the suction unit shown in FIG. 7;

FIG. 10 is a cross-sectional view of the device for drying electrodes shown in FIG. 1, taken along line A1-A2; and

FIG. 11 is a block diagram illustrating internal components of the device for drying electrodes according to an embodiment of the present disclosure.

### DETAILED DESCRIPTION OF THE INVENTION

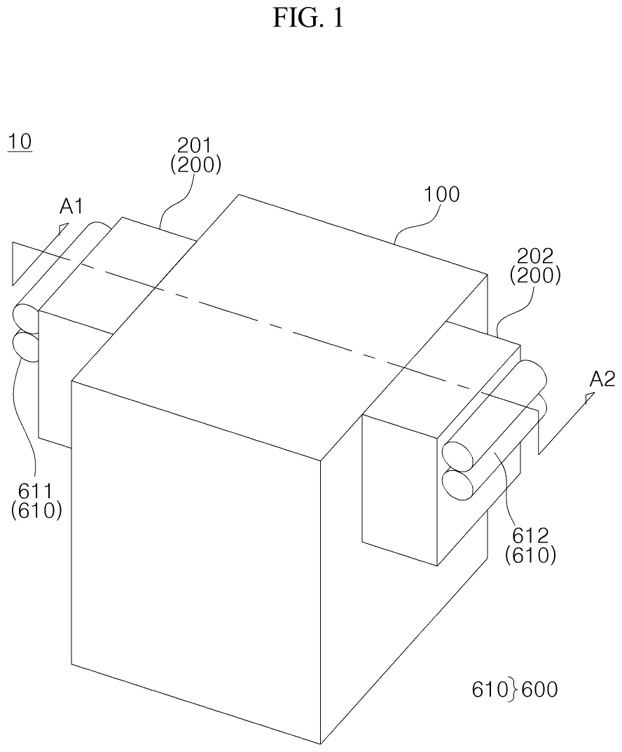

Hereinafter, the present disclosure will be described in detail through embodiments with reference to the accompanying FIGS. 1 to 11. However, the embodiments are merely illustrative and the present disclosure is not limited to the specific embodiments described by way of example.

FIG. 1 is a view illustrating a device for drying electrodes according to an embodiment of the present disclosure.

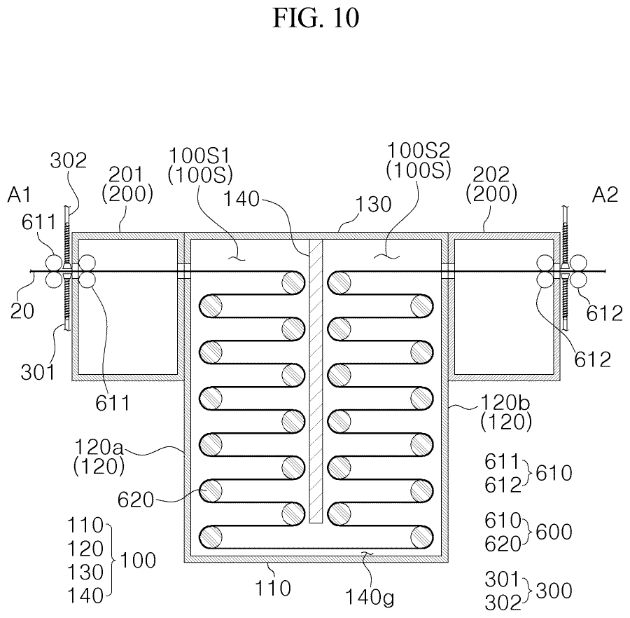

Referring to FIG. 1, a device 10 for drying electrodes (“drying electrode device 10”) may be configured to dry an electrode sheet 20 (see FIG. 10). The electrode sheet 20 (see FIG. 10) may have a shape extending in a single direction. The electrode sheet 20 (see FIG. 10) may have a sheet-like shape. The electrode sheet 20 (see FIG. 10) may be used in a secondary battery.

The drying electrode device 10 may include a roll assembly 600. The roll assembly 600 may transport the electrode sheet 20 (see FIG. 10). The roll assembly 600 may include a transit roll 610.

The device may be provided with a plurality of transit rolls 610. For example, the roll assembly 600 may include an inlet transit roll 611 and an outlet transit roll 612. The transit roll 610 may include or refer to at least one of the inlet transit roll 611 and the outlet transit roll 612.

The drying electrode device 10 may include a drying chamber 100. The drying chamber 100 may have a space formed therein. Heat may be applied to the inside of the drying chamber 100.

The drying electrode device 10 may include a transit chamber 200. The transit chamber 200 may be connected to or in communication with the drying chamber 100.

The device may be provided with a plurality of transit chambers 200. For example, the drying electrode device 10 may include an inlet chamber 201 and an outlet chamber 202. The transit chamber 200 may include or refer to at least one of the inlet chamber 201 and the outlet chamber 202.

The electrode sheet 20 (see FIG. 10) may be introduced into the inlet chamber 201. The electrode sheet 20 (see FIG. 10) introduced into the inlet chamber 201 may be transported to the drying chamber 100 by the roll assembly 600.

For example, the inlet transit roll 611 may be connected to or coupled with the inlet chamber 201. For example, the inlet transit roll 611 may be disposed adjacent to the inlet chamber 201. The inlet transit roll 611 may introduce the electrode sheet 20 (see FIG. 10) into the inlet chamber 201 (see FIG. 10).

The electrode sheet 20 (see FIG. 10) that has entered the drying chamber 100 may be dried inside the drying chamber 100. For example, the electrode sheet 20 (see FIG. 10) may receive heat inside the drying chamber 100.

The electrode sheet 20 (see FIG. 10) positioned within the drying chamber 100 may enter the outlet chamber 202. The electrode sheet 20 (see FIG. 10) that has entered the outlet chamber 202 may be transported by the roll assembly 600 and discharged to the outside of the outlet chamber 202.

For example, the outlet transit roll 612 may be connected to or coupled with the outlet chamber 202. For example, the outlet transit roll 612 may be disposed adjacent to the outlet chamber 202. The outlet transit roll 612 may discharge the electrode sheet 20 (see FIG. 10) from the outlet chamber 202 (see FIG. 10).

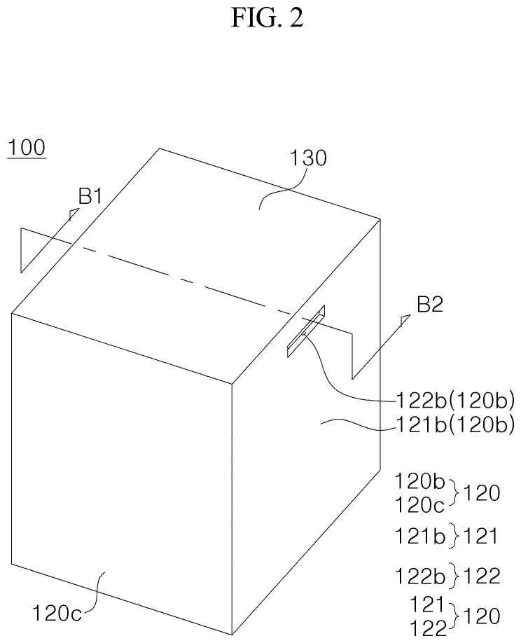

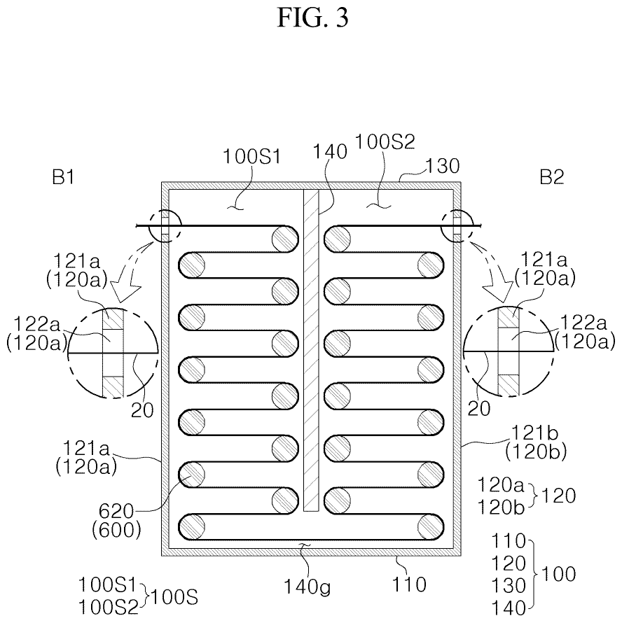

FIG. 2 is a view illustrating the drying chamber shown in FIG. 1. FIG. 3 is a cross-sectional view of the drying chamber shown in FIG. 2, taken along line B1-B2. For convenience of description, the electrode sheet may be illustrated in FIG. 3.

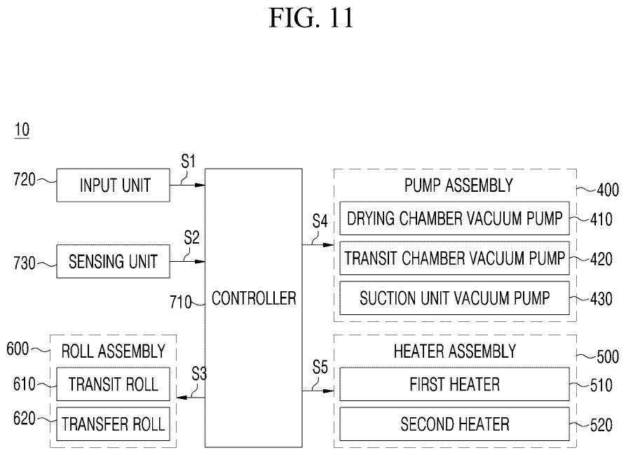

Referring to FIGS. 2 and 3, the drying chamber 100 may have a space formed therein. For example, the drying chamber 100 may have a drying space 100S formed therein. The pressure of the drying space 100S may be lower than the pressure outside the drying chamber 100. For example, a drying chamber vacuum pump 410 (see FIG. 11) may be connected to the drying chamber 100 to draw in gas (or air) present in the drying space 100S.

The drying space 100S may be divided into a plurality of sections. For example, the drying space 100S may be divided into a first drying space 100S1 and a second drying space 100S2. For example, the drying space 100S may include the first drying space 100S1 and the second drying space 100S2. For example, the drying space 100S may be divided into the first drying space 100S1 and the second drying space 100S2 by means of a partition 140.

The drying chamber 100 may include a drying chamber bottom 110. The drying chamber bottom 110 may form a bottom portion of the drying chamber 100. The drying chamber bottom 110 may form a lower surface of the drying chamber 100.

The drying chamber 100 may include a drying chamber top 130. The drying chamber top 130 may form an upper surface of the drying chamber 100. The drying chamber top 130 may be disposed above the drying chamber bottom 110.

The drying chamber 100 may include a drying chamber wall 120. The drying chamber wall 120 may connect the drying chamber top 130 and the drying chamber bottom 110. For example, the drying chamber wall 120 may extend upward from the drying chamber bottom 110 and continue to the drying chamber top 130.

The drying chamber wall 120 may include a drying chamber inlet wall 120a. The drying chamber inlet wall 120a may include a drying chamber inlet wall body 121a. The drying chamber inlet wall body 121a may face the inlet chamber 201 (see FIG. 1). For example, an inlet chamber 201 may be located outside the drying chamber 100 and may be in contact with the drying chamber inlet wall 120a.

The drying chamber inlet wall 120a may include a drying chamber inlet wall slit 122a. The drying chamber inlet wall slit 122a may be a slit formed in the drying chamber inlet wall body 121a. For example, the drying chamber inlet wall slit 122a may extend between an inner surface and an outer surface of the drying chamber inlet wall body 121a.

The drying chamber wall 120 may include a drying chamber outlet wall 120b. The drying chamber outlet wall 120b may include a drying chamber outlet wall body 121a. For example, the drying chamber outlet wall body 121b may face the outlet chamber 202 (see FIG. 1). For example, an outlet chamber 202 may be located outside the drying chamber 100 and may be in contact with the drying chamber outlet wall 120b.

The drying chamber outlet wall 120b may include a drying chamber outlet wall slit 122b. The drying chamber outlet wall slit 122b may be a slit formed in the drying chamber outlet wall body 121b. For example, the drying chamber outlet wall slit 122b may extend between an inner surface and an outer surface of the drying chamber outlet wall body 121b.

The drying chamber wall 120 may include a drying chamber connection wall 120c. The drying chamber connection wall 120c may connect the drying chamber inlet wall 120a and the drying chamber outlet wall 120b.

The drying chamber 100 may include the partition 140. The partition 140 may divide the drying space 100S into the first drying space 100S1 and the second drying space 100S2.

The partition 140 may be located between the drying chamber inlet wall 120a and the drying chamber outlet wall 120b. For example, the partition 140 may be located between the drying chamber inlet wall slit 122a and the drying chamber outlet wall slit 122b.

The partition 140 may be connected to one of the drying chamber top 130 and the drying chamber bottom 110 and spaced from the other. For example, an upper end of the partition 140 may be connected to the drying chamber top 130, and a lower end of the partition 140 may be spaced from the drying chamber bottom 110.

For example, a partition gap 140g may be formed between the lower end of the partition 140 and the drying chamber bottom 110. The electrode sheet 20 may pass through the partition gap 140g.

The electrode sheet 20 may enter the inside of the drying chamber 100 by passing through the drying chamber inlet wall slit 122a. For example, the electrode sheet 20 that has passed through the drying chamber inlet wall slit 122a may be positioned in the first drying space 100S1.

The electrode sheet 20 positioned in the first drying space 100S1 may be transported by the transport roll 620. The electrode sheet 20 may be dried in the first drying space 100S1 by a first heater 510 (see FIG. 11).

The electrode sheet 20 may pass through the partition gap 140g in the first drying space 100S1 and enter the second drying space 100S2. The electrode sheet 20 that has entered the second drying space 100S2 may be transported by the transport roll 620.

The electrode sheet 20 may be dried in the second drying space 100S2 by the second heater 520 (see FIG. 11). The heat output of the second heater 520 (see FIG. 11) may be lower than the heat output of the first heater 510 (see FIG. 11).

For example, the temperature of the first drying space 100S1 may be higher than the temperature of the second drying space 100S2. For example, the temperature of the gas provided by the first heater 510 (see FIG. 11) may be higher than the temperature of the gas provided by the second heater 520 (see FIG. 11).

The partition 140 may have at least one of an insulating property and a heat-resistant property. For example, the partition 140 may be formed of a material including at least one of glass fiber, calcium silicate, and cellular glass.

The roll assembly 600 may include a transport roll 620. The transport roll 620 may transport the electrode sheet 20. The device may be provided with a plurality of transport rolls 620. The plurality of transport rolls 620 may be located within the drying chamber 100.

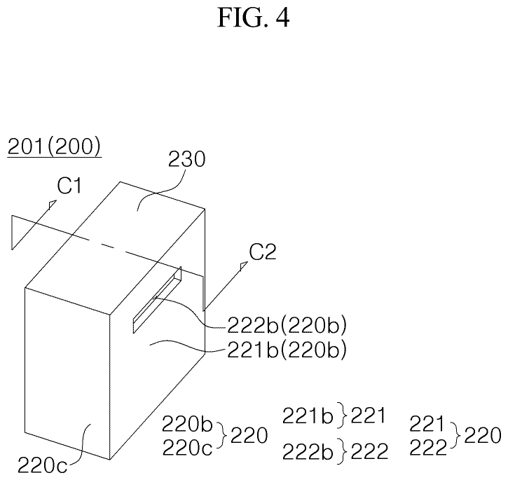

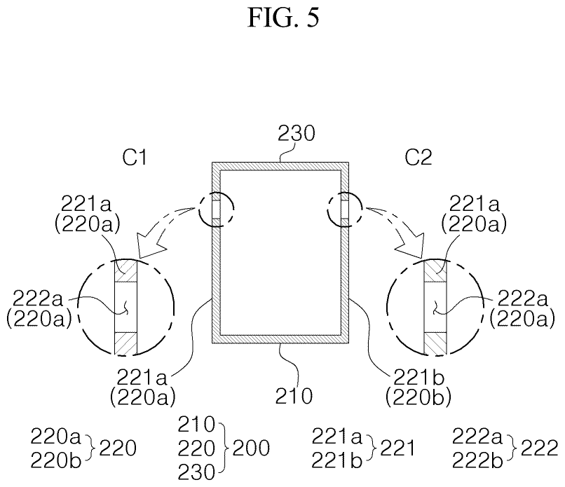

FIG. 4 is a view illustrating the transit chamber shown in FIG. 1. FIG. 5 is a cross-sectional view of the transit chamber shown in FIG. 4 along line C1-C2.

Referring to FIG. 4 and FIG. 5, the transit chamber 200 may have a space formed therein. For example, the electrode sheet 20 (see FIG. 10) may pass through the internal space formed in the transit chamber 200.

The pressure of the internal space of the transit chamber 200 may be lower than the pressure outside the transit chamber 200. For example, a transit chamber vacuum pump 420 (see FIG. 11) may be connected to the transit chamber 200 to draw in gas (or air) present in the internal space of the transit chamber 200. The pressure of the internal space of the transit chamber 200 may be higher than the pressure of the drying space 100S (see FIG. 3) of the drying chamber 100 (see FIG. 3).

The transit chamber 200 may include a transit chamber bottom 210. The transit chamber bottom 210 may form a bottom portion of the transit chamber 200. The transit chamber bottom 210 may form a lower surface of the transit chamber 200.

The transit chamber 200 may include a transit chamber top 230. The transit chamber top 230 may form an upper surface of the transit chamber 200. The transit chamber top 230 may be disposed above the transit chamber bottom 210.

The transit chamber 200 may include a transit chamber wall 220. The transit chamber wall 220 may connect the transit chamber top 230 and the transit chamber bottom 210. For example, the transit chamber wall 220 may extend upward from the transit chamber bottom 210 and continue to the transit chamber top 230.

The transit chamber wall 220 may include a transit chamber inlet wall 220a. The transit chamber inlet wall 220a may include a transit chamber inlet wall body 221a. The transit chamber inlet wall body 221a of the outlet chamber 202 (see FIG. 1) may face the drying chamber outlet wall 120b (see FIG. 3).

The transit chamber inlet wall 220a may include a transit chamber inlet wall slit 222a. The transit chamber inlet wall slit 222a may be a slit formed in the transit chamber inlet wall body 221a.

For example, the transit chamber inlet wall slit 222a of the outlet chamber 202 (see FIG. 1) may be connected to or in communication with the drying chamber outlet wall slit 122b (see FIG. 3).

For example, the electrode sheet 20 (see FIG. 10) may sequentially pass through the drying chamber outlet wall slit 122b (see FIG. 3) and the transit chamber inlet wall slit 222a of the outlet chamber 202 (see FIG. 1).

For example, the electrode sheet 20 (see FIG. 10) may pass through the transit chamber inlet wall slit 222a of the inlet chamber 201 and enter the inside of the inlet chamber 201.

The transit chamber wall 220 may include a transit chamber outlet wall 220b. The transit chamber outlet wall 220b may be located on the opposite side of the transit chamber inlet wall 220a. For example, an inner side of the transit chamber outlet wall 220b may face an inner side of the transit chamber inlet wall 220a.

The transit chamber outlet wall 220b may include a transit chamber outlet wall body 221b. For example, the transit chamber outlet wall body 221b of the inlet chamber 201 may face the drying chamber inlet wall 120a (see FIG. 3) of the drying chamber 100 (see FIG. 3).

The transit chamber outlet wall 220b may include a transit chamber outlet wall slit 222b. The transit chamber outlet wall slit 222b may be a slit formed in the transit chamber outlet wall body 221b.

For example, the transit chamber outlet wall slit 222b of the inlet chamber 201 may be connected to or in communication with the drying chamber inlet wall slit 122a (see FIG. 3). For example, the electrode sheet 20 (see FIG. 10) may sequentially pass through the transit chamber outlet wall slit 222b of the inlet chamber 201 and the drying chamber inlet wall slit 122a (see FIG. 3).

For example, the electrode sheet 20 (see FIG. 10) positioned within the outlet chamber 202 (see FIG. 1) may pass through the transit chamber outlet wall slit 222b of the outlet chamber 202 (see FIG. 1) and be discharged to the outside of the outlet chamber 202 (see FIG. 1).

The transit chamber wall body 221 may include or refer to at least one of the transit chamber inlet wall body 221a and the transit chamber outlet wall body 221b.

The transit chamber wall slit 222 may include or refer to at least one of the transit chamber inlet wall slit 222a and the transit chamber outlet wall slit 222b.

The transit chamber wall 220 may include a transit chamber connection wall 220c. The transit chamber connection wall 220c may connect the transit chamber inlet wall 220a and the transit chamber outlet wall 220b.

The transit chamber wall bodies 221a and 221b may include or refer to at least one of the transit chamber inlet wall body 221a and the transit chamber outlet wall body 221b.

The transit chamber wall slits 222a and 222b may include or refer to at least one of the transit chamber inlet wall slit 222a and the transit chamber outlet wall slit 222b.

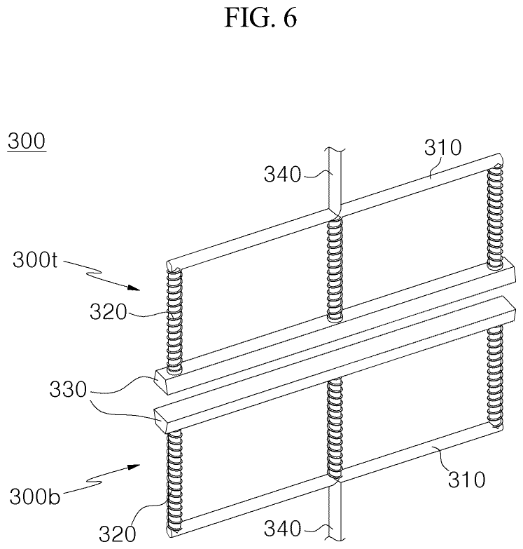

FIG. 6 is a view illustrating a suction unit according to an embodiment of the present disclosure.

Referring to FIG. 6, the drying electrode device 10 (see FIG. 1) may include a suction unit 300. The suction unit 300 may include an upper suction module 300t and a lower suction module 300b.

The upper suction module 300t and the lower suction module 300b may face each other. The suction modules 300t and 300b may include or refer to at least one of the upper suction module 300t and the lower suction module 300b.

The lower suction module 300b may be located below the upper suction module 300t. The lower suction module 300b may be spaced apart from the upper suction module 300t.

The transit chamber inlet wall slit 222a of the inlet chamber 201 (see FIG. 1) may face a space between the upper suction module 300t and the lower suction module 300b of the inlet suction unit 301 (see FIG. 10).

The transit chamber outlet wall slit 222b of the outlet chamber 202 (see FIG. 1) may face a space between the upper suction module 300t and the lower suction module 300b of the outlet suction unit 302 (see FIG. 10).

The suction modules 300t and 300b may each include a suction frame 310. The suction frame 310 may be aligned parallel to the transit chamber wall slits 222a and 222b (see FIG. 5).

For example, the suction frame 310 may have a shape extending in a longitudinal direction. The longitudinal direction of the suction frame 310 may be parallel to the longitudinal direction of the transit chamber wall slits 222a and 222b (see FIG. 5). For example, the longitudinal direction of the suction frame 310 may be parallel to the width direction of the electrode sheet 20 (see FIG. 10).

For example, the suction frame 310 may face an outer surface of the transit chamber outlet wall 220b (see FIG. 5) of the outlet chamber 202 (see FIG. 1). For example, the suction frame 310 may face an outer surface of the transit chamber inlet wall 220a (see FIG. 5) of the inlet chamber 201 (see FIG. 1).

The suction modules 300t and 300b may each include a suction rod 320. The device may be provided with a plurality of suction rods 320. The suction rod 320 may be connected to or coupled with the suction frame 310. For example, the suction rod 320 may have a shape extending from the suction frame 310.

For example, the suction rod 320 of the upper suction module 300t may extend from the suction frame 310 of the upper suction module 300t toward the lower suction module 300b.

For example, the suction rod 320 of the lower suction module 300b may extend from the suction frame 310 of the lower suction module 300b toward the upper suction module 300t.

The suction modules 300t and 300b may each include a suction cup 330. The longitudinal direction of the suction cup 330 may be parallel to the longitudinal direction of the transit chamber wall slits 222a and 222b (see FIG. 5).

The suction cup 330 may be connected to or coupled with the suction rod 320. For example, the suction cup 330 may be movably or slidably coupled to the suction rod 320.

The suction cups 330 may face the electrode sheet 20 (see FIG. 10). For example, inner surfaces of the suction cups 330 may face the electrode sheet 20 (see FIG. 10).

For example, the inner surface of the suction cup 330 of the upper suction module 300t may face the suction cup 330 of the lower suction module 300b with the electrode sheet 20 interposed therebetween. Similarly, the inner surface of the suction cup 330 of the lower suction module 300b may face the suction cup 330 of the upper suction module 300t. The inner surface of the suction cup 330 may be concave.

The suction modules 300t and 300b may each include a suction hose 340. The suction hose 340 may be connected to the suction frame 310.

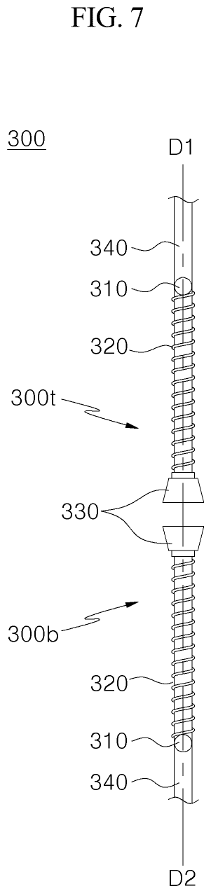

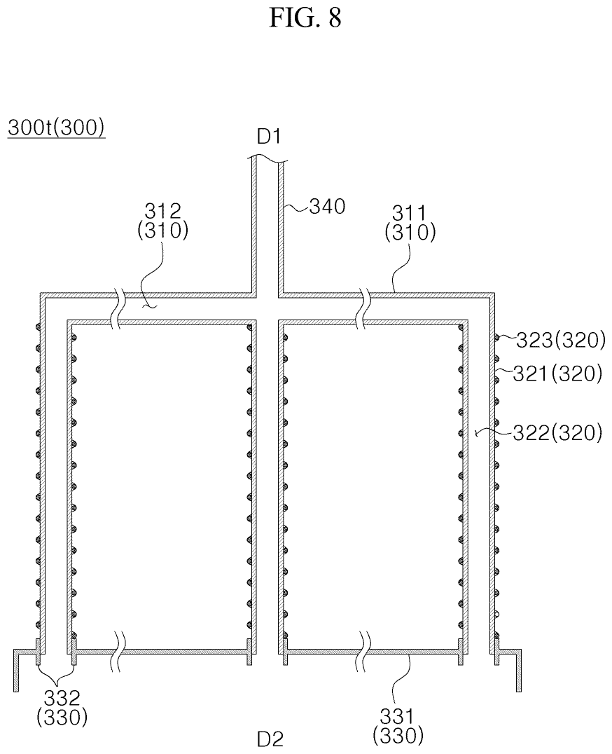

FIG. 7 is a view illustrating the suction unit shown in FIG. 6 as viewed from a different angle. FIG. 8 is a partial cross-sectional view of the suction unit shown in FIG. 7, taken along line D1-D2. For convenience of description, the illustration of the lower suction module 300b is omitted in FIG. 8.

Referring to FIGS. 7 and 8, a hollow portion may be formed inside the suction hose 340. For example, one end of the suction hose 340 may be connected to or coupled with the suction frame 310, and the other end of the suction hose 340 may be connected to a suction unit vacuum pump 430 (see FIG. 11).

The suction frame 310 may include a suction frame body 311. The suction frame body 311 may form an outer shape of the suction frame 310. The suction frame body 311 may be connected to or coupled with the suction hose 340 and the suction rod 320.

The suction frame 310 may include a suction frame flow path 312. The suction frame flow path 312 may be formed in the suction frame body 311. For example, the suction frame flow path 312 may be a hollow portion formed in the suction frame body 311. The suction frame flow path 312 may be connected to or in communication with the hollow portion formed in the suction hose 340.

The suction rod 320 may include a suction rod body 321. The suction rod body 321 may be connected to or coupled with the suction frame body 311. For example, one end of the suction rod body 321 may be connected to or coupled with the suction frame body 311, and the other end of the suction rod body 321 may be connected to or coupled with the suction cup 330.

For example, the suction rod body 321 may have a shape extending from the suction frame body 311. For example, the suction rod body 321 may have a shape that extends from the suction frame body 311 and continues to the suction cup 330.

The suction rod 320 may include a suction rod flow path 322. The suction rod flow path 322 may be a hollow portion formed in the suction rod body 321. The suction rod flow path 322 may be connected to or in communication with the suction frame flow path 312. For example, one end of the suction rod flow path 322 may be connected to or in communication with the suction frame flow path 312, and the other end of the suction rod flow path 322 may be connected to or in communication with the suction cup 330.

The suction rod 320 may include a suction rod elastic part 323. The suction rod elastic part 323 may have elasticity. For example, when the shape of the suction rod elastic part 323 is deformed, elastic energy may be stored in the suction rod elastic part 323, which will serve as a restoring force when the suction rod elastic part 323 is returned to its original shape. For example, the suction rod elastic part 323 may include a spring.

One end of the suction rod elastic part 323 may be connected to, coupled with, or fixed to at least one of the suction rod body 321 and the suction frame body 311. The other end of the suction rod elastic part 323 may be connected to, coupled with, or fixed to the suction cup 330.

The suction cup 330 may include a suction cup body 331. An inner surface of the suction cup body 331 may be concave. A portion of an outer surface of the suction cup body 331 may face the suction frame 310.

The suction cup 330 may include a suction cup guide 332. The suction cup guide 332 may be connected to or coupled with the suction cup body 331. For example, the suction cup guide 332 may have a shape extending from the suction cup body 331. The suction cup guide 332 may have a pipe shape.

The suction cup guide 332 may be coupled to the suction rod body 321. For example, the suction cup guide 332 may be movably or slidably coupled to the suction rod body 321.

For example, one end of the suction rod body 321 may be connected to the suction frame body 311, and the other end of the suction rod body 321 may be movably or slidably coupled to the suction cup guide 332.

For example, as shown in FIG. 8, the other end of the suction rod body 321 may be accommodated in the suction cup guide 332. For another example, at least a portion of the suction cup guide 332 may be located in the suction rod flow path 322.

When the suction unit vacuum pump 430 operates, the gas or air present in the suction hose 340 may be drawn in. When the gas or air flows from the suction hose 340 to the suction unit vacuum pump 430, the pressure in the suction frame flow path 312 may become higher than the pressure inside the suction hose 340. Therefore, when the suction unit vacuum pump 430 operates, the gas or air present in the suction frame flow path 312 may flow into the suction hose 340.

When gas or air present in the suction frame flow path 312 flows into the suction hose 340, the pressure in the suction frame flow path 312 may become lower than the pressure in the suction rod flow path 322. Therefore, when the suction unit vacuum pump 430 operates, the gas or air present in the suction rod flow path 322 may flow into the suction frame flow path 312.

When gas or air present in the suction rod flow path 322 flows into the suction frame flow path 312, the pressure in the suction rod flow path 322 may become lower than the pressure in the suction cup 330. Therefore, when the suction unit vacuum pump 430 operates, the gas or air present in the suction cup 330 may flow into the suction rod flow path 322.

Therefore, when the suction unit vacuum pump 430 operates, at least a portion of the gas (or air) present in the suction cup 330 may sequentially pass through the suction rod flow path 322, the suction frame flow path 312, and the suction hose 340, and reach the suction unit vacuum pump 430.

When the suction unit vacuum pump 430 operates, the gas (or air) around the suction cup 330 may move toward the suction cup guide 332. Due to the flow of gas (or air) around the suction cup 330, a pressure directed toward the suction frame 310 may be applied to the suction cup 330.

Due to the pressure applied to the suction cup 330, the suction cup 330 may move toward the suction frame 310. When the suction cup 330 moves toward the suction frame 310, elastic energy serving as the restoring force may be stored in the suction rod elastic part 323.

The suction cup 330 may be located outside the transit chamber 200 (see FIG. 10) at a position adjacent to the transit chamber wall slit 222. When the suction unit vacuum pump 430 (see FIG. 11) operates, the pressure in the region outside the transit chamber 200 (see FIG. 10) may decrease near the transit chamber wall slit 222.

For example, the suction cup 330 may be disposed adjacent to the transit chamber inlet wall slit 222a (see FIG. 5) of the inlet chamber 201 (see FIG. 1). Alternatively, the suction cup 330 may be disposed adjacent to the transit chamber outlet wall slit 222b (see FIG. 5) of the outlet chamber 202 (see FIG. 1).

Therefore, when the suction unit vacuum pump 430 (see FIG. 11) operates, the gas (or air) present outside the transit chamber 200 may be prevented from entering the inside of the transit chamber 200 through the transit chamber wall slit 222. As a result, the pressure inside the transit chamber 200 may be effectively maintained lower than the atmospheric pressure.

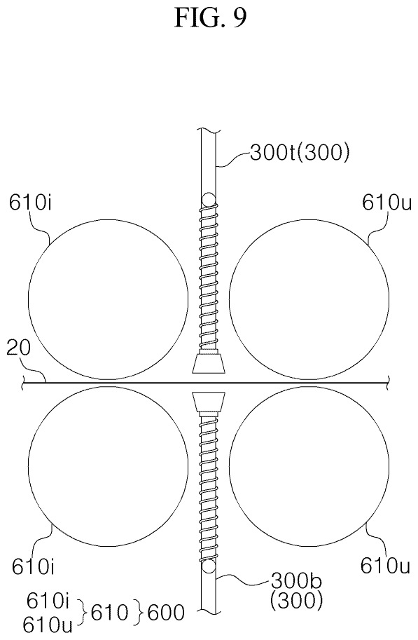

FIG. 9 is a view illustrating a state where the transit rolls are arranged in the suction unit shown in FIG. 7. FIG. 10 is a cross-sectional view of the device for drying electrodes shown in FIG. 1, taken along line A1-A2.

Referring to FIG. 9 and FIG. 10, the transit roll 610 may be disposed adjacent to the transit chamber 200. For example, a portion of the transit roll 610 may be located outside the transit chamber 200, and another portion of the transit roll 610 may be located inside the transit chamber 200.

The device may be provided with a plurality of transit rolls 610. For example, the inlet transit roll 611 may be disposed adjacent to the inlet chamber 201. Similarly, the outlet transit roll 612 may be disposed adjacent to the outlet chamber 202. The transit roll 610 may include or refer to at least one of the inlet transit roll 611 and the outlet transit roll 612.

The transit roll 610 may include an outer transit roll 610u. The outer transit roll 610u may be located outside the transit chamber 200.

For example, the outer transit roll 610u of the inlet transit roll 611 may be located outside the inlet chamber 201, facing the transit chamber inlet wall 220a (see FIG. 5) of the inlet chamber 201.

Similarly, the outer transit roll 610u of the outlet transit roll 612 may be located outside the outlet chamber 202, facing the transit chamber outlet wall 220b of the outlet chamber 202 (see FIG. 5).

The transit roll 610 may include an inner transit roll 610i. The inner transit roll 610i may be located inside the transit chamber 200.

For example, the inner transit roll 610i of the inlet transit roll 611 may be positioned within the inlet chamber 201, facing the transit chamber inlet wall 220a of the inlet chamber 201 (see FIG. 5).

Similarly, the inner transit roll 610i of the outlet transit roll 612 may be located inside the outlet chamber 202, facing the transit chamber outlet wall 220b of the outlet chamber 202 (see FIG. 5).

For example, the transit chamber inlet wall 220a of the inlet chamber 201 (see FIG. 5) may be located between the inner transit roll 610i of the inlet transit roll 611 and the outer transit roll 610u.

Similarly, the transit chamber outlet wall 220b of the outlet chamber 202 (see FIG. 5) may be located between the inner transit roll 610i of the outlet transit roll 612 and the outer transit roll 610u.

The device may be provided with a plurality of suction units 300. For example, the inlet suction unit 301 may be disposed adjacent to the inlet chamber 201. Similarly, the outlet suction unit 302 may be disposed adjacent to the outlet chamber 202. The suction unit 300 may include or refer to at least one of the inlet suction unit 301 and the outlet suction unit 302.

For example, the transit chamber inlet wall 220a of the inlet chamber 201 (see FIG. 5) may be located between the inner transit roll 610i of the inlet transit roll 611 and the inlet suction unit 301.

Similarly, the inlet suction unit 301 may be located between the transit chamber inlet wall 220a of the inlet chamber 201 (see FIG. 5) and the outlet transit roll 612 of the inlet transit roll 611.

For example, the transit chamber outlet wall 220b of the outlet chamber 202 (see FIG. 5) may be located between the inner transit roll 610i of the outlet transit roll 612 and the outlet suction unit 302.

Similarly, the outlet suction unit 302 may be located between the transit chamber outlet wall 220b of the outlet chamber 202 (see FIG. 5) and the outer transit roll 610u of the outlet transit roll 612.

FIG. 11 is a block diagram illustrating internal components of the device for drying electrodes according to an embodiment of the present disclosure.

Referring to FIGS. 1 to 11, the electrode sheet 20 may have a shape extending in a single direction. The electrode sheet 20 may be flexible. The electrode sheet 20 may be transported by the roll assembly 600. Among the portions of the electrode sheet 20, a portion corresponding to a certain section range in the length direction of the electrode sheet 20 may be referred to as a “target electrode.”

The target electrode 20 may be transported by the inlet transit roll 610. The target electrode 20 may pass between the upper suction module 300t and the lower suction module 300b of the inlet suction unit 301. The inlet suction unit 301 may suppress the internal pressure of the inlet chamber 201 from increasing.

The target electrode 20 that has passed between the upper suction module 300t and the lower suction module 300b of the inlet suction unit 301 may enter the inside of the inlet chamber 201 by passing through the transit chamber inlet wall slit 222a of the inlet chamber 201.

The target electrode 20 that has entered the inside of the inlet chamber 201 may sequentially pass through the transit chamber outlet wall slit 222b of the inlet chamber 201 and the drying chamber inlet wall slit 122a.

The target electrode 20 that has passed through the drying chamber inlet wall slit 122a may be positioned in the first drying space 100S1. The target electrode 20 positioned in the first drying space 100S1 may be transported in the first drying space 100S1 by the transport roll 620.

The first heater 510 may be located, for example, in the first drying space 100S1. The first heater 510 may provide heat to the first drying space 100S1.

For example, the first heater 510 may provide heat to the gas or air present in the first drying space 100S1. A “first space temperature” may be the temperature of the gas or air present in the first drying space 100S1.

The first heater 510 may provide heat to the target electrode 20 positioned in the first drying space 100S1. For example, the first heater 510 may irradiate the target electrode 20 positioned in the first drying space 100S1 with infrared rays.

For example, the first heater 510 may supply a first gas to the target electrode 20 positioned in the first drying space 100S1. A “first gas temperature” may be the temperature of the first gas. The humidity of the first gas may be relatively low. The target electrode 20 positioned in the first drying space 100S1 may be dried.

The target electrode 20 positioned in the first drying space 100S1 may pass between the partition 140 and the drying chamber bottom 110. For example, the target electrode 20 positioned in the first drying space 100S1 may enter the second drying space 100S2 by passing through the partition gap 140g. The target electrode 20 that has entered the second drying space 100S2 may be transported in the second drying space 100S2 by the transport roll 620.

The second heater 520 may be located, for example, in the second drying space 100S2. The second heater 520 may provide heat to the second drying space 100S2.

For example, the second heater 520 may provide heat to the gas or air present in the second drying space 100S2. A “second space temperature” may be a temperature of the gas or air present in the second drying space 100S2. The second space temperature may be lower than the first space temperature.

The second heater 520 may provide heat to the target electrode 20 positioned in the second drying space 100S2. For example, the second heater 520 may irradiate the target electrode 20 positioned in the second drying space 100S2 with infrared rays.

For example, the second heater 520 may supply a second gas to the target electrode 20 positioned in the second drying space 100S2. A “second gas temperature” may be the temperature of the second gas. The humidity of the second gas may be relatively low. The target electrode 20 positioned in the second drying space 100S2 may be dried. The second gas temperature may be lower than the first gas temperature.

The target electrode 20 positioned in the second drying space 100S2 may pass through the drying chamber outlet wall slit 122b. The target electrode 20 that has passed through the drying chamber outlet wall slit 122b may then pass through the transit chamber inlet wall slit 222a of the outlet chamber 202.

The target electrode 20 that has passed through the transit chamber inlet wall slit 222a of the outlet chamber 202 may be positioned within the outlet chamber 202. The target electrode 20 positioned within the outlet chamber 202 may be transported by the roll assembly 600 and may pass through the transit chamber outlet wall slit 222b of the outlet chamber 202.

The target electrode 20 that has passed through the transit chamber outlet wall slit 222b of the outlet chamber 202 may then pass between the upper suction module 300t and the lower suction module 300b of the outlet suction unit 302. The outlet suction unit 302 may suppress the internal pressure of the outlet chamber 202 from increasing.

The target electrode 20 that has passed between the upper suction module 300t and the lower suction module 300b of the outlet suction unit 302, may be transported to the outside of the drying electrode device 10.

The drying electrode device 10 may include a controller 710. The controller 710 may process signals. The controller 710 may perform operations. The controller 710 may be implemented by at least one of a processor, a computer, an electric circuit, a circuit board (CB), a printed circuit board (PCB), and a server.

The drying electrode device 10 may include an input unit 720. The input unit 720 may obtain an input from a user or the like. The input unit 720 may transmit a first signal S1 to the controller 710.

The first signal S1 may include information regarding the input obtained by the input unit 720. For example, the first signal S1 may include an operation command for at least one of the roll assembly 600, the pump assembly 400, and the heater assembly 500.

The drying electrode device 10 may include a sensing unit 730. The sensing unit 730 may measure, for example, the thickness of the target electrode 20 that is introduced into the inlet chamber 201 or discharged from the outlet chamber 202.

The sensing unit 730 may transmit a second signal S2 to the controller 710. The second signal S2 may include information regarding the thickness of the target electrode 20.

The controller 710 may generate output signals S3, S4 and S5 based on the input signals S1 and S2. The input signals S1 and S2 may include or refer to at least one of the first signal S1 and the second signal S2. The output signals S3, S4 and S5 may include or refer to at least one of a third signal S3, a fourth signal S4, and a fifth signal S5.

The controller 710 may transmit the third signal S3 to the roll assembly 600. The third signal S3 may include information regarding the operation of the roll assembly 600. For example, the third signal S3 may include information regarding the transport speed of the electrode sheet 20. The roll assembly 600 may operate according to the third signal S3.

The controller 710 may transmit the fourth signal S4 to the pump assembly 400. The fourth signal S4 may include information regarding the operation of the pump assembly 400.

For example, the fourth signal S4 may include information regarding the output of at least one of the drying chamber vacuum pump 410, the transit chamber vacuum pump 420, and the suction unit vacuum pump 430.

The controller 710 may transmit the fifth signal S5 to the heater assembly 500. The fifth signal S5 may include information regarding the operation of the heater assembly 500. The heater assembly 500 may operate according to the fifth signal S5.

The contents described above are merely examples of applying the principles of the present disclosure, and other configurations may be further included without departing from the scope of the present disclosure.

What is claimed is:

1. A device for drying electrodes comprising:
a drying chamber having a drying space formed therein and comprising a drying chamber inlet wall and a drying chamber outlet wall that face each other;
an inlet chamber located outside the drying chamber and in contact with the drying chamber inlet wall;
an outlet chamber located outside the drying chamber and in contact with the drying chamber outlet wall;
a roll assembly including a plurality of transport rolls located in the drying space; and
a heater assembly configured to provide heat to the drying space,
wherein the drying chamber further comprises a partition located in the drying space to divide the drying space into a first drying space and a second drying space, and
the heater assembly comprises a first heater configured to provide heat to the first drying space and a second heater configured to provide heat to the second drying space.

2. The device for drying electrodes according to claim 1, wherein an output of the first heater is greater than an output of the second heater.

3. The device for drying electrodes according to claim 1, wherein the first heater is configured to supply a first gas to the first drying space,
the second heater is configured to supply a second gas to the second drying space, and
a temperature of the first gas is higher than a temperature of the second gas.

4. The device for drying electrodes according to claim 1, wherein the drying chamber comprises: a drying chamber bottom that forms a lower surface of the drying chamber; and a drying chamber top that forms an upper surface of the drying chamber,
wherein the partition is connected to one of the drying chamber bottom and the drying chamber top and spaced from the other.

5. The device for drying electrodes according to claim 4, wherein the partition extends downward from the drying chamber top and is spaced apart from the drying chamber bottom.

6. The device for drying electrodes according to claim 1, wherein the partition is formed of a material comprising at least one of glass fiber, calcium silicate, and cellular glass.

7. The device for drying electrodes according to claim 1, wherein a pressure of the drying space is lower than an internal pressure of the inlet chamber and an internal pressure of the outlet chamber.

8. The device for drying electrodes according to claim 1, wherein each of the inlet chamber and the outlet chamber comprises a transit chamber inlet wall and a transit chamber outlet wall that face each other,
the transit chamber outlet wall of the inlet chamber is in contact with the drying chamber inlet wall, and
the transit chamber inlet wall of the outlet chamber is in contact with the drying chamber outlet wall.

9. The device for drying electrodes according to claim 8, wherein the transit chamber inlet wall comprises: a transit chamber inlet wall body; and a transit chamber inlet wall slit formed in the transit chamber inlet wall body, and
the transit chamber outlet wall comprises a transit chamber outlet wall body; and a transit chamber outlet wall slit formed in the transit chamber outlet wall body.

10. The device for drying electrodes according to claim 9, wherein the device further comprises an inlet suction unit disposed adjacent to the transit chamber inlet wall slit of the inlet chamber and located outside the inlet chamber; and
an outlet suction unit disposed adjacent to the transit chamber outlet wall slit of the outlet chamber and located outside the outlet chamber,
wherein each of the inlet suction unit and the outlet suction unit is configured to draw in external gas.

11. The device for drying electrodes according to claim 10, wherein each of the inlet suction unit and the outlet suction unit comprises an upper suction module configured to draw in external gas; and
a lower suction module located below the upper suction module and configured to draw in external gas.

12. The device for drying electrodes according to claim 11, wherein the transit chamber inlet wall slit of the inlet chamber faces a space formed between the upper suction module and the lower suction module of the inlet suction unit, and
the transit chamber outlet wall slit of the outlet chamber faces a space formed between the upper suction module and the lower suction module of the outlet suction unit.

13. The device for drying electrodes according to claim 11, wherein each of the upper suction module and the lower suction module comprises:
a suction frame extending in a longitudinal direction of at least one of the transit chamber inlet wall slit and the transit chamber outlet wall slit;
a suction rod extending from the suction frame; and
a suction cup coupled to the suction rod and extending in the longitudinal direction of the suction frame.

14. The device for drying electrodes according to claim 13, wherein the suction cup is movably connected to the suction rod.

15. The device for drying electrodes according to claim 14, wherein the suction rod comprises:
a suction rod body coupled to the suction frame;
a suction rod flow path formed inside the suction rod body and in communication with the suction cup; and
a suction rod elastic part having one end connected to at least one of the suction rod body and the suction frame, and the other end connected to the suction cup and having elasticity.

16. The device for drying electrodes according to claim 15, wherein the suction cup comprises:
a suction cup body having a concave inner surface and a portion of an outer surface facing the suction frame; and
a suction cup guide extending from the suction cup body and movably coupled to the suction rod body.
